(19) United States
(12) Patent Application Publication
(10) Pub. No.: US 2010/0284594 A1
(43) Pub. Date: Nov. 11, 2010

(54) Method and Device for 3d-Navigation On Layers of Images

(75) Inventors: Karl-Heinz Hohne, Pinneberg (DE); Rudolf Leuwer, Krefeld (DE); Andreas Petersik, Hamburg (DE); Bernhard Pflesser, Hamburg (DE); Andreas Pommert, Buxtehude (DE); Ulf Tiede, Wentdorf (DE)

Correspondence Address: Alan B. Clement;Locke Lord Bissell & Liddell LLC, 885 Third Avenue, 26th Floor, New York, NY, 10022-4802, US

(73) Assignee: UNIVERSITAETSKLINKUM HAMBURG-EPPENDORF, Hamburg (DE)

(21) Appl. No.: 11/922,555

(22) PCT Filed: Jun. 23, 2006
(86) PCT No.: PCT/DE2006/001077

§ 371 Date: Aug. 2, 2010

(30) Foreign Application Priority Data
Jun. 25, 2005 (DE) 10 2005 029 903.2

(51) Int. Cl. G06K 9/00; G06T 15/00

(52) U.S. Cl. 382/131; 345/419

(57) ABSTRACT

The invention relates to a device and to a method for representing 2D-layers of images of internal structures. The invention enables the physical expansion of a tool to be represented in a 3D manner in 2D layers of images of internal structures and to represent modifications on said internal structures, in particular bone structures, by means of an operation tool for preparing, performing, displaying, reproducing, further processing or learning a surgical operation.

The invention relates to device and a method for displaying two-dimensional image layers of internal structures. The invention enables the physical dimension of a tool in 2D image layers of internal structures, and also changes to the internal structures, to be represented three-dimensionally. A particular object of the invention is to show the progress of a material removing operation both in real time on two-dimensional (2D), computer-generated images and if necessary simultaneously with computer-generated, displayed three-dimensional (3D) models, wherein the effect of the tool used for the operation, the three-dimensional layout of the tool in relation to one or more 2D layer images, and particularly both, are displayed. The invention may be used for preparation, performance, recording, reproduction, or for learning a surgical procedure.

Surgeons currently view a number of static views of the operating site on a patient in preparation for and/or during a surgical procedure. These data may be generated from methods for producing cross sectional images such as computer tomography (CT), magnetic resonance tomography (MRT), ultrasound, positron emission tomography (PET), or combinations thereof. Each of these techniques creates a flat, lattice-like arrangement (matrix) of values for each of a sequence of layers of an object. Usually, the solid object is a human body or a part of the body, although the method may equally well be applied to other natural or man-made solid objects.

In the case of CT scanning, the physical value would be the coefficient of X-ray absorption. In MRT imaging, the physical value would be the spin-spin or spin-lattice relaxation time. In either case, the physical values measures reflect the changes in the composition, density or surface characteristics of the underlying physical structures.

Since it is only possible to provide two-dimensional layer images using conventional imaging methods, surgeons must deduce the actual three-dimensional position and shape of the internal structures under consideration from the 2D images they are seeing. As a consequence, 3D models have been developed that show the internal structures, and particularly the organs, of a operating site.

These models are used for example to support navigation during a real operation. In this context, the real position of the tip of the instrument is mapped to the computer model using known techniques, so that e.g. the corresponding sagittal, coronal or transverse layers that pass through that point are shown. However, this still means that the surgeon cannot visualize the position and orientation of his instrument in three dimensions relative to the layers, or identify the area that has already been removed or dealt with.

One object of the present invention consists in creating a system that renders the progress of a real or simulated drilling or trimming operation identifiable on 2D layers and also on 3D views at the same time as required. In particular, it is designed to represent both the area removed and the position and orientation of the instrument in three dimensions on the layer images and in real time, so that the progress and effect of the operating instrument may be shown in space and time, archived, and possibly replayed at a later time.

The present invention is by the independent claims. Preferred embodiments are described in the subordinate claims and also in the following text.

In particular, the object of the invention is a method for displaying two-dimensional layer images of internal structures, including the representation in the 2D layer images
of the physical dimension of a 3D tool and/or its movement in the internal structures and/or
of changes to one or more internal structures caused by the instrument, preferably both,
   wherein the method includes the following steps:
producing a data volume that defines the physical dimension of the internal structures by a plurality of spatial coordinates and one variable that corresponds to a physical measurement value and is assigned to each site that is described by the coordinates,
generating a plurality of volume elements from the data volume, wherein
   attributes may be assigned to each of the volume elements, and volume elements with assigned attributes represent a 3D model of the internal structures, and
   at least one attribute characterises association with an internal structure and enables its representation, wherein the attribute may be obtained by segmenting the volume elements using the variable that corresponds to the physical measurement value, and
capturing the spatial coordinates of an instrument via an electronic input device and
extracting and displaying of 2D layer images of any position and orientation from the 3D model by mapping a representative of the tool and/or its position,
   characterised in that
   the method further includes at least the following steps selected from group: (a) or (b), preferably from both (a) and (b):
(a) generation of a tool as a 3D computer simulation and mapping of the tool as a 3D object in the 2D layer image, including its 3D alignment relative to the 2D layer image
   and/or
(b) providing at least those volume elements describing the parts of the internal structures that are able to be processed with an attribute indicating the processing status, creating an intersection of the volume elements that are designated as being capable of being processed and of the volume that is concealed by the active area of the tool when it is operating during the processing operation, and marking the volume elements of the intersection by assigning the “processed” attribute and displaying the cuts through the volume elements that are identified with the “processed” attribute as marked surfaces in the 2D layer images.

The invention further relates to a device for carrying out the method described above the device having,
(i) an imaging device for recording and generating volumetric three-dimensional image data of internal structures and for outputting volumetric three-dimensional image data,
(ii) a data processing system including a memory and a processor and a software program for producing a data volume from the volumetric three-dimensional image data, for generating a plurality of volume elements from the data volume and for extracting and displaying 2D layer images in any position and orientation from the 3D model by mapping a representation of the tool and its position, wherein the data processing system represents tools in the form of a 3D computer simulation, and enables them to be selected,
(iii) an electronic input unit for entering the spatial coordinates of the tool, and
(iv) a display for (a) mapping the tool as a 3D object in the 2D layer image as well as the 3D alignment relative to the 2D layer image, and/or (b) representing the section or sections through the volume elements that are identified with the “processed” attribute as marked surfaces in the 2D layer images, wherein the data processing system assigns the “processed” attribute to volume elements that describe the structure that has been processed when the active area of the tool intersects the volume elements in the switched on operating mode.

The variable that corresponds to the physical measurement value is preferably converted to an item of brightness information to represent volume elements or the section through the volume elements with differing levels of brightness, wherein the marked surfaces reflect the brightness, e.g. on a different colour scale depending on their marking.

Medical imaging devices such as a computer tomograph (CT), a magnetic resonance tomograph (MRT), an ultrasound device or a positron emission tomograph (PET) are suitable imaging devices.

The electronic input unit may be a navigation system that fixes the direction of the real tool and records the movement and possibly the size thereof, or a 3D input device that preferably exerts a force feedback on the hand of the user.

In order to display the 2D layer images (and the 3D images), a 3D display device that shows stereo images may be used, particularly for showing the 3D tool, wherein right and left images of at least the 3D tool are displayed stereoscopically. The 3D model, possibly with the tool, is preferably shown correspondingly with the associated 2D layer image on a display, and more preferably, those 2D layer images that constantly intersect a certain point of the active area, for example the active area of the tool are generated by the data processing device and then displayed as the tool is moved.

Internal bodily structures and the part of the internal structures such as bone, cartilage and/or teeth or parts thereof that have or are to be processed are particularly suitable objects for such representation. Besides these structures, the status of their processing, either simulated or in actuality with a real tool, may also be displayed and recorded as a temporal expression or progression.

The advantage over conventional navigation consists in that the regions which have been removed may be displayed in any way, regardless of the respective position of the tool. On the monitor, particularly on the 2D layers as well, the operator sees the spatial expression of his tool relative to the anatomy, which provides crucial assistance in orientation. Additionally, the progression of the real operation may be documented quantitatively, e.g., with the capability to take measurements subsequently or with the cutting planes in any inclined position, also selected afterwards.

The technique by which three-dimensional representations of the operating site on a patient may be obtained is generally known. Spatial sequences of the layer images described previously are combined in a 3D matrix of measurement values (image volume), each point of which is furnished with at least one measurement value and possibly other attributes. These attributes may describe for example association with an organ or the processing status (e.g. removed with the operating tool/not removed with the operating tool) for example.

From such a 3D model, it is possible to extract spatial views (3D representation) of the internal structures and/or 2D layer images in any position and orientation.

Unlike conventional navigation, the tool is not assumed to be in the form of a point in the present invention, instead it is recorded and described in terms of its three-dimensional properties. In this way, it is possible to capture areas that have been processed with the tool corresponding to the shape of the tool. Technical details for modifying the volume model to show the effect of an operating tool are available in the publication “Volume cutting for virtual petrous bone surgery” in Comput. Aided Surg. 7, 2 (2002), 74-83 by Bernhard Pflesser, Andreas Petersik, Ulf Tiede, Karl Heinz Höhne and Rudolf Leuwer. The disclosed content of that publication is also included as the object of this application by this reference thereto.

Besides supporting navigation, the same procedure may also be used for training and preoperative simulation of surgical procedures on the basis of the 3D model. In this case, the tool is represented by a three-dimensional, virtual model that may be guided by the user with a 3D input device. In a preferred embodiment, the 3D input device exerts a force feedback on the user's hand. An input device of such kind measures the position in space (3 coordinates) and the direction of a stylus (vector with 3 components) by which the device is guided. A corresponding program calculates the forces to be expected with reference to the 3D model of the anatomy and the position and shape of the tool. For this purpose, the surface of the tool is furnished with a series of scanning points which constantly check whether a collision between the object to be processed and the tool has occurred. In such a case, a force that is proportional to the penetration depth is induced in the direction of the object surface. Devices such as the Phantom® Omni, produced by SensAble Technologies that are marketed commercially for such purpose may be used as the 3D input device with force feedback.

The force feedback method is explained in detail in IS4TM 2003: 194-202, “Realistic Haptic Interaction in Volume Sculpting for Surgery Simulation” by Andreas Petersik, Bernhard Pflesser, Ulf Tiede, Karl Heinz Höhne and Rudolf Leuwer. The disclosed content of that publication is also included as the object of this application by this reference thereto.

The invention will now be explained with reference to the accompanying figures.

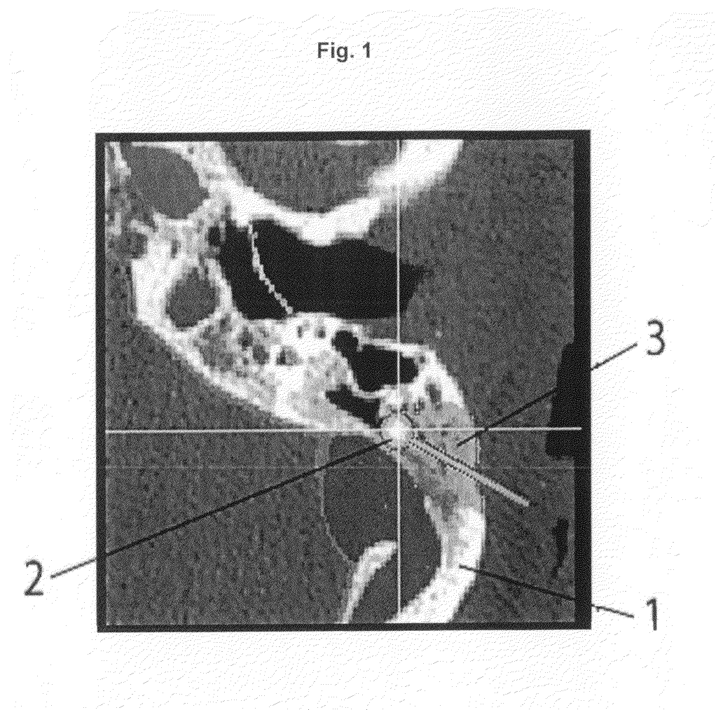

FIG. 1 shows an image layer that represents a bone structure (1), a three-dimensional drilling tool (2) and a drilling volume (3) that has been removed in the bone with a coloured marking (in this case dark grey). The layer image is a 2D section through the 3D space. The drilling tool (2) is represented as a 3D body in its current 3D alignment relative to the cut in the space (transverse layer).

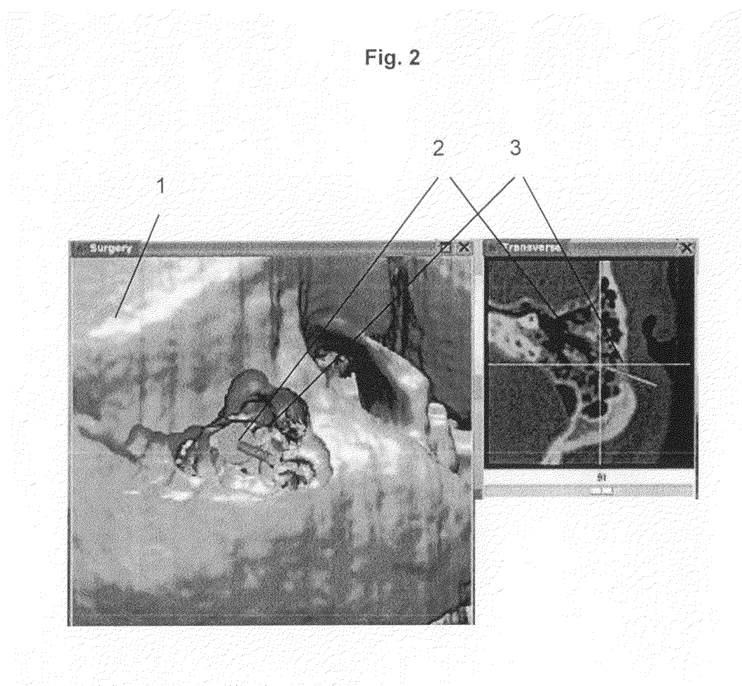

FIG. 2 shows two images. In detail, they depict a transverse layer image (right) and a 3D model, calculated and displayed from the data volume. The region modified as determined by the size and motion of the drill is marked in the 3D volume model and is also shown on the 2D cut image, as well as a three-dimensional image of the drilling tool (2).

An example of the method according to the invention will be explained in detail in the following as a series of steps, wherein the example can be easily generalized with respect to one or more of the individual steps
(1) A spatial sequence of CT images is taken, usually transversely, to capture a representation of the operation site on layer images (2D images).
(2) An image volume (or 3D matrix) is generated from the layer images and consists of, for example, 512×512×256 addressable volume elements (voxels), each of which is provided with intensity values (typically on a scale from 0 to 4095).
(3) Assignment of attributes to the volume elements, wherein at least one attribute defines association with a given object (segmentation). The object may then be selected and displayed on the basis of this attribute.
(4) Selection of a tool or tool type, e.g., as a polygonal 3D object. The tool is normally scalable.
(5) Definition of an active area (working surface, e.g., drill head) and a passive area (e.g., shaft) of the tool.
(6) Activation and deactivation of the tool's working surface.
(7) Movement of the tool in the space, guided by the acquisition of the spatial data from an actual tool relative to the object during a surgical procedure using conventional navigation systems, or from an electronic 3D input device, preferably with force feedback.
   When the working surface is deactivated, the tool may be guided through the free space and may be used to scan the (mostly solid) bodily structures.
(8) Cutting (creation of the intersection between the volume elements (e.g., bone) distinguished by an attribute and the active area of the tool.
(9) Marking this intersection of volume elements by allocating an additional “processed” attribute.
(10) Extraction of 2D layer images from the 3D volume, preferably in the direction of at least one body axis (transverse, sagittal or coronal) through the centre of the working surface, or selected at will. In this context, the volume elements identified with “processed” are preferably displayed by colouring while retaining the intensity values supplied by the imaging method.
(11) Representation of the tool as a 3D object shaded by computer graphics methods and in its spatial relationship to the 2D layer image.

1. A method for displaying two-dimensional layer images of internal structures, including the representation in the 2D layer images
of the physical dimension of a 3D tool and its movement in the internal structures and/or
of changes to one or more internal structures caused by the tool, preferably both,
wherein the method includes the following steps:
producing a data volume that defines the physical dimension of the internal structures by a plurality of spatial coordinates and one variable that corresponds to a physical measurement value and is assigned to each site that is described by the coordinates,
generating a plurality of volume elements from the data volume, wherein
attributes may be assigned to each of the volume elements, and the volume elements with assigned attributes represent a 3D model of the internal structures, and
at least one attribute characterizes the association with an internal structure and enables its visualization, wherein the attribute may be obtained by segmenting the volume elements using the variable that corresponds to the physical measurement value,
capturing the spatial coordinates of a tool via an electronic input device and
moving the instrument
characterized in that
the displayed 2D layer images intersect the active area of the tool and follow its movement, and
the displayed 2D layer images of any position and orientation are extracted from the 3D model by mapping a representative of the tool and its position and
the method further includes at least the following steps from the group (a) or (b), preferably from both (a) and (b),
(a) generation of a tool as a 3D computer simulation and mapping of the tool as a 3D object in the 2D layer image, including its 3D alignment relative to the 2D layer image
and/or
(b) providing at least those volume elements describing the parts of the internal structures that are able to be processed with an attribute indicating the processing status, creating an intersection of the volume elements that are designated as being capable of being processed and of the volume that is concealed by the active area of the tool when it is operating during the processing operation, and
marking the volume elements of the intersection by assigning the “processed” attribute, and
displaying the cut or cuts through the volume elements that are identified with the “processed” attribute as marked surfaces in the 2D layer image(s).

2. The method according to claim 1, characterized in that the variable that corresponds to the physical measurement value is an item of brightness information for displaying volume elements or the 2D cut through the volume elements with different brightness levels, wherein the marked surface reproduces the brightness according to the marking on a different color scale.

3. The method according to claim 1, characterized in that the internal structures are body structures and the parts of the internal structures that have been/are to be processed are bone, cartilage and/or teeth or parts thereof.

4. The method according to claim 1, characterized in that the 3D matrix of spatial coordinates is derived from layer images, such as are provided by medical imaging methods such as computer tomography (CT), magnetic resonance tomography (MRI), ultrasound, positron emission tomography (PET), or combinations thereof.

5. The method according to claim 1, characterized in that the electronic input unit records the spatial coordinates of a real tool via a navigation system and the tool is guided through the mapped internal structure and processes parts thereof, wherein the structure in the 3D model corresponds to an image of the real structure including its processing status, and the real tool possibly receives an information about its proximity to a structure or a risk structure from the 3D model, and informs the operator of this.

6. The method according to claim 1, characterized in that the electronic input unit includes a 3D input device that preferably exerts a force feedback on the hand of the user.

7. The method according to claim 1, characterized in that the 2D layer images are displayed with a 3D display device that shows stereo images for displaying the 3D tool, wherein stereoscopic right and left images of at least the 3D tool are shown.

8. The method according to claim 1, characterized in that a 3D model continues to be represented correspondingly with at least one 2D layer image.

9. The method according to claim 1, characterized in that the tool is shown in the 2D layer image, wherein the 3D dimension and orientation are optically simulated with computer graphics methods.

10. The method according to claim 1, characterized in that the movement of the tool is recorded in the form of the 2D layer images shown, and possibly converted into video sequences.

11. The method according to claim 1, characterized in that the method includes the steps of both groups (a) and (b).

12. A device, possibly multiple-part, for displaying 2D layer images of internal structures, including the representation in the 2D layer images
of the physical dimension of a 3D tool and its movement in the internal structures and
of changes to one or more internal structures caused by the tool, preferably both,
wherein the device comprises
(i) an imaging device for recording and generating volumetric three-dimensional image data of internal structures and for outputting volumetric three-dimensional image data,
(ii) a data processing system including a memory and a processor and a software program
for producing a data volume from the volumetric three-dimensional image data defining the physical dimension of the internal structure via a plurality of spatial coordinates and a variable that corresponds to a physical measurement value and is assigned to each side that is described by the coordinates,
for generating a plurality of volume elements from the data volume, wherein
the volume elements, each may be associated with attributes, and the volume elements associated with attributes represent a 3D model of the internal structure, and
at least one attribute characterizes the association with an internal structure and enables its representation, wherein the attribute may be obtained by segmenting the volume elements using the variable that corresponds to the physical measurement value, and
wherein the data processing system holds tools as 3D computer simulation, and enables them to be selected,
(iii) an electronic input unit for entering the spatial coordinates of the tool and for moving the tool relative to the internal structures, and
(iv) a display
characterized in that
the data processing system generates those 2D layer images from the 3D model that constantly intersect a certain point of the active area of the tool when the tool is moved, and the display shows these 2D layer images, and
the 2D layer images of any position and orientation shown on the display are extracted from the 3D model by the data processing system by mapping a representation of the tool and its position,
and the display shows:
(a) the image of the tool as a 3D object in the 2D layer image and of the 3D alignment relative to the 2D layer image,
and
(b) the representation of the section or sections through the volume elements that are identified with the “processed” attribute as marked surfaces in the 2D layer image(s), wherein the data processing system assigns the “processed” attribute to the volume elements that describe the structure that has been processed when the active area of the tool intersects the volume elements in the switched on operating mode.

13. The device according to claim 12, characterized in that the variable that corresponds to the physical measurement value is converted to an item of brightness information to represent volume elements or the section through the volume elements with differing levels of brightness, wherein the marked surfaces reflect the brightness on a different color scale depending on marking.

14. The device according to claim 12, characterized in that the imaging devices is a medical imaging device such as a computer tomograph (CT), a magnetic resonance tomography (MRT), an ultrasound device, or a positron emission tomograph (PET).

15. The device according to claim 12, characterized in that the electronic input unit includes a navigation system that locates the real tool.

16. The device according to claim 12, characterized in that the electronic input unit includes a 3D input device, which preferably exerts a force feedback on the user's hand.

17. The device according to claim 12, characterized in that the display of the 2D layer images takes place via a 3D display device that shows stereo images for displaying the 3D tool, wherein stereoscopic right and left images of at least of the 3D tool are displayed.

18. The device according to claim 12, characterized in that a 3D model is shown on the display corresponding with the associated 2D layer image.
